(19) United States
(12) Patent Application Publication
(10) Pub. No.: US 2025/0138816 A1
(43) Pub. Date: May 1, 2025

(54) REFACTORING NON-COMPLIANT CODE INTO COMPLIANT CODE

(71) Applicant: Microsoft Technology Licensing, LLC, Redmond, WA (US)

(72) Inventors: Justin Allen HUTCHINGS, Sammamish, WA (US); Ryan Joseph SALVA, Palm Springs, CA (US)

(21) Appl. No.: 18/384,348

(22) Filed: Oct. 26, 2023

(51) Int. Cl. G06F 8/72; G06F 8/71

(52) U.S. Cl. CPC G06F 8/72; G06F 8/71

(57) ABSTRACT

Techniques for intelligently prompting an LLM to refactor code are disclosed. A code snippet is accessed. This code is identified as potentially comprising a reference to an out-of-compliance library. Context for the code snippet is generated. An LLM prompt is then built. This prompt will be fed to the LLM, and the prompt instructs the LLM to refactor the code snippet into modified code, which calls a compliant library. Output of the LLM is displayed. This output is based on the LLM operating in response to the LLM prompt. The output includes a proposed rewritten version of the code snippet.

### BACKGROUND

Modern software development relies on large ecosystems of libraries to perform various operations, such as network communication, mathematical optimization, and so on. Open-source libraries (e.g., pandas in Python) are ubiquitous. These open-source libraries are often supported by a buoyant community of users and contributors. Many of these libraries are also rapidly evolving to add user-requested features, to improve performance, or to support new use cases. Such operations often result in breaking application programming interface (API) changes. Sometimes, these operations also result in the libraries or APIs becoming non-compliant with a governing body of policy. As various examples, the library may adopt a license which is not allowed by the organization, or the library may become vulnerable to a known CVE (common vulnerabilities and exposures).

It is also the case that attempting to have existing users update to the latest version or to a compliant version can be a challenge. For example, new users often end up using older code versions simply because there is more example code and more tutorials for those older versions than for the latest version. These problems are exacerbated by language-model based developer tools (e.g., GitHub Copilot) whose training corpus is generally heavily biased towards older library versions, meaning that they are likely to suggest code using outdated idioms and deprecated APIs. Sometimes, these tools may even incorrectly suggest non-compliant code.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

In some aspects, the techniques described herein relate to a method for intelligently prompting a large language model (LLM) to refactor code, said method including: accessing a code snippet, which is identified as potentially including a reference to an out-of-compliance library; generating context for the code snippet; building an LLM prompt that will be fed to the LLM, wherein the LLM prompt instructs the LLM to refactor the code snippet into modified code, which calls a compliant library; and displaying output of the LLM based on the LLM operating in response to the LLM prompt, wherein the output includes a proposed rewritten version of the code snippet.

In some aspects, the techniques described herein relate to a computer system including: a processor system; and a storage system that includes instructions that are executable by the processor system to cause the computer system to: access a code snippet, which is identified as potentially including code that is uncompliant with a policy; generate context for the code snippet; build a large language model (LLM) prompt that will be fed as input to an LLM, wherein the LLM prompt instructs the LLM to refactor the code snippet into modified code, which is designed to be compliant with the policy; and display output of the LLM based on the LLM operating in response to the LLM prompt, wherein the output includes a proposed rewritten version of the code snippet.

In some aspects, the techniques described herein relate to a method including: accessing a code snippet, which is identified as potentially including at least one of (i) a reference to an out-of-compliance library or (ii) code that is uncompliant with a policy; generating context for the code snippet; building a large language model (LLM) prompt that will be fed as input to an LLM, wherein the LLM prompt instructs the LLM to refactor the code snippet into modified code, which either (i) calls a compliant library or (ii) is compliant with the policy; and displaying output of the LLM based on the LLM operating in response to the LLM prompt, wherein the output includes at least one of (i) a proposed rewritten version of the code snippet or (ii) an indication that the LLM is unable to either (a) fix the code snippet so that the code snippet calls the compliant library or (b) fix the code snippet so that the code snippet is compliant with the policy.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an example computing architecture for refactoring code.

FIG. 2 illustrates an example of a set of release notes that may optionally detail various code mappings.

FIG. 3 illustrates an example of a large language model (LLM) prompt.

FIGS. 4A, 4B, 4C, and 4D illustrate various outputs of the LLM.

FIG. 5 illustrates a flowchart of an example method for refactoring code.

FIG. 6 illustrates an example computer system that can be configured to perform any of the disclosed operations.

### DETAILED DESCRIPTION

The disclosed embodiments generally deal with the problem of updating code that uses non-compliant or perhaps even deprecated or obsolete third-party library application programming interfaces (APIs). The disclosed embodiments bring about numerous benefits, advantages, and practical applications to the technical field of code management. By way of example, the embodiments improve how code is managed and updated. In doing so, the embodiments help avoid scenarios where code becomes non-compliant with a governing body of policy. The embodiments also help avoid scenarios where code becomes obsolete or otherwise breaks, thereby improving how a computer system functions and operates. By improving the code, the embodiments also improve the user's experience with the computer system and improve how code is maintained so as to remain in a compliant state.

To achieve these benefits, the embodiments generally rely on the use of language models, the use of context associated with a user's code snippet (e.g., a section of code that is calling a library or API), and the use of code mapping information (e.g., information from a dependency graph, or perhaps mapping information obtained from “release notes” or “change notes”). It is typically the case that a library's release notes contain information about policy, deprecated, or removed APIs as well as advice on how to update client code that uses them. For example, given a snippet of code that is known or suspected of being used in an API, the embodiments can feed the snippet, context for that snippet, as well as mapping data (e.g., perhaps pulled from a collection of relevant dependency graph information or release notes) to the language model. The embodiments can then prompt the language model to rewrite or “refactor” the code so that a lateral shift is made to the code while preserving the underlying functionality. Stated differently, the embodiments rewrite the code so that its functionality is the same, but this rewrite results in the code now being compliant with policy or results in the code having call statements to a library that is compliant with a policy. In some cases, the code previously called a non-compliant library. The embodiments are able to rewrite the code so that the user's code now calls a different library that is compliant with the policy.

By performing the above operations, the embodiments significantly improve how code structures are updated and used. The embodiments also improve how code is maintained and developed. Furthermore, the embodiments are able to prompt developers to improve how they structure their code. Accordingly, these and numerous other benefits will now be described in more detail throughout the remaining sections of this disclosure.

### Example Architectures

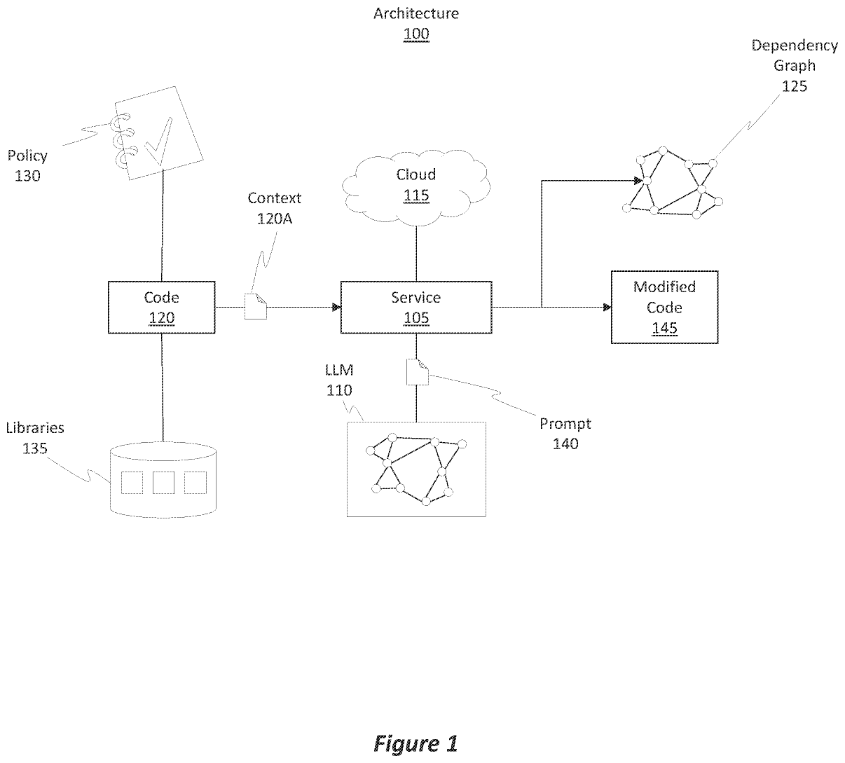

Having just described some of the high level benefits provided by the disclosed embodiments, attention will now be directed to FIG. 1, which illustrates an example architecture 100 that can be used to achieve those benefits. Architecture 100 is shown as including a service 105. As used herein, the term “service” refers to an automated program that is tasked with performing different actions based on input. In some cases, service 105 can be a deterministic service that operates fully given a set of inputs and without a randomization factor. In other cases, service 105 can be or can include a machine learning (ML) or artificial intelligence engine. The ML engine enables service 105 to operate even when faced with a randomization factor.

As used herein, reference to any type of machine learning or artificial intelligence may include any type of machine learning algorithm or device, convolutional neural network(s), multilayer neural network(s), recursive neural network(s), deep neural network(s), decision tree model(s) (e.g., decision trees, random forests, and gradient boosted trees) linear regression model(s), logistic regression model(s), support vector machine(s) (“SVM”), artificial intelligence device(s), or any other type of intelligent computing system. Any amount of training data may be used (and perhaps later refined) to train the machine learning algorithm to dynamically perform the disclosed operations.

Service 105 is shown as including or being associated with a large language model (LLM) 110. LLM 110 can be representative of the machine learning engine or artificial intelligence described above. LLM 110 is a type of neural network that uses various layers of nodes in a probabilistic manner. LLM 110 generates probabilities for words to form various groupings of words in response to prompts. LLM 110 can be a first-party LLM or a third-party LLM.

In some implementations, service 105 is a cloud service operating in a cloud environment 115. In some implementations, service 105 is a local service operating on a local device. In some implementations, service 105 is a hybrid service that includes a cloud component operating in the cloud and a local component operating on a local device. These two components can communicate with one another.

Service 105 accesses a code snippet, as shown by code 120. Code 120 is typically included in a larger codebase. For instance, code 120 may be a line of code, a function of code, a module, or perhaps an entire program.

Service 105 parses at least the code 120. Often, service 105 will parse the entire codebase. Service 105 will the inject the parsed data into a dependency graph 125 (e.g., a type of relational data store), which represents the dependencies, versions, vulnerabilities, and licenses of code in a repository, such as perhaps open source code. Stated differently, the dependency graph 125 is able to determine the version, vulnerability, and license behind any piece of source code (including open source code) that is being used in a repository. Using this dependency graph 125, the embodiments are able to determine whether a user's code is using the latest version of the open source code or is using code that calls a library that is determined to be compliant with a governing policy.

The parsed data is inserted into the dependency graph 125 as additional nodes, line items, or additional information in the graph. In some cases, service 105 is able to perform various pre-filtering operations to identify APIs or libraries that are known to be compliant with the policy. Furthermore, service 105 can perform pre-filtering operations to remove APIs or libraries that are known to not be compliant. The pre-filtering operations can also be performed to filter packages or code blocks that are known to be allowed. If the user's code snippet is calling a library that is not included in the pre-filtered list, then service 105 can determine that the user is relying on a library or API (or any other coding structure) that is potentially not compliant with the governing policy.

In some implementations, service 105 further parses a manifest associated with the codebase. Service 105 may parse a lockfile associated with the codebase. Service 105 may also parse metadata associated with the codebase. This parsed data may also be inserted into the dependency graph 125.

The dependency graph 125 can then be analyzed to determine whether the code 120 is in compliance with a policy 130 and/or includes calls to libraries 135 that may be out of compliance with the policy 130. That is, as a result of the parsed information being inserted into the dependency graph 125, service 105 will be able to discern whether the code 120 is considered compliant code or non-compliant code.

If the code 120 is considered to not be compliant, service 105 may then generate or collect additional context 120A associated with the code 120. As one example, the context 120A may include content obtained from a selected number of preceding lines of code relative to the line or lines of code comprising the code 120. Similarly, the context 120A may include content obtained from a selected number of succeeding lines of code relative to the line or lines of code comprising the code 120. The context 120A may include program or file calls, metadata, release note data, or any other data.

Service 105 then builds a prompt 140 that will be fed as input to the LLM 110. The prompt 140 instructs the LLM 110 to refactor the code 120 into modified code, which is designed to be compliant with the policy 130, such as by including call statements to libraries that are compliant with the policy 130. For instance, the user's code may have previously called a non-compliant library. The LLM 110 can be tasked with identifying an equivalent library (in terms of functionality), but this equivalent library is determined to be compliant with the policy. The LLM 110 can then be further tasked with rewriting the user's code so that it no longer calls the older library; instead, the code is rewritten to now call the new (compliant) library.

The prompt 140 may be structured to include the code 120, the policy 130, the context 120A, and any number of example mappings that may help guide the LLM 110 in its determination. For instance, these mappings may map the out-of-compliance library or code to a compliant library or code. More generally, the service or dependency graph may maintain equivalence classes of libraries that offer similar capabilities. For example, the embodiments can maintain a list of libraries that perform database queries. The service may also use the LLM to obtain a list of libraries that perform similar tasks to a known library.

In this manner, prompt 140 may include various code mappings or release note comments detailing how certain non-compliant code is mapped to compliant code. These prompt line items can help guide the LLM 110 in generating its output. This refactor process operates to laterally shift the code. That is, this refactor process changes the syntax of the code so that the syntax conforms with the policy 130 while, at the same time, substantially keeping the functionality of the code the same, even if a different library or API is now being called. Therefore, despite potentially having different syntax, the new code will have the same functionality as the previous code.

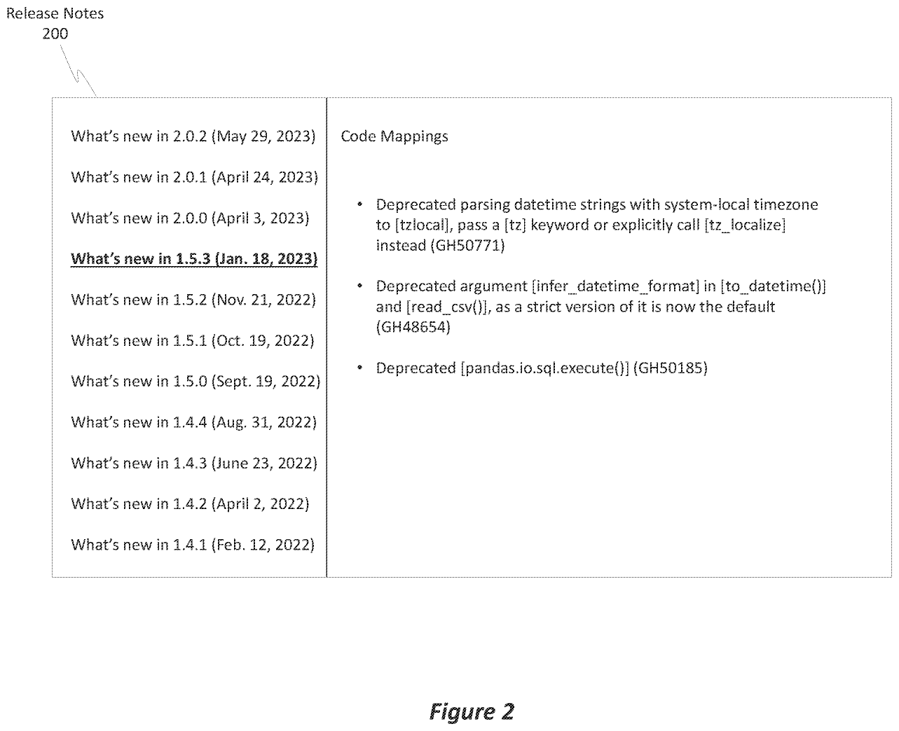

Turning briefly to FIG. 2, this figure illustrates one example of a set of release notes 200 that may be used to help generate the mappings mentioned earlier. The release notes 200 include information about deprecations or policy guidelines and their alternatives or replacements. The release notes 200 may further include mappings as to how to bring code from a non-compliant state to a compliant state with respect to certain policy. LLM 110 can be configured in a manner to understand the release notes 200 and to translate them into corresponding code changes.

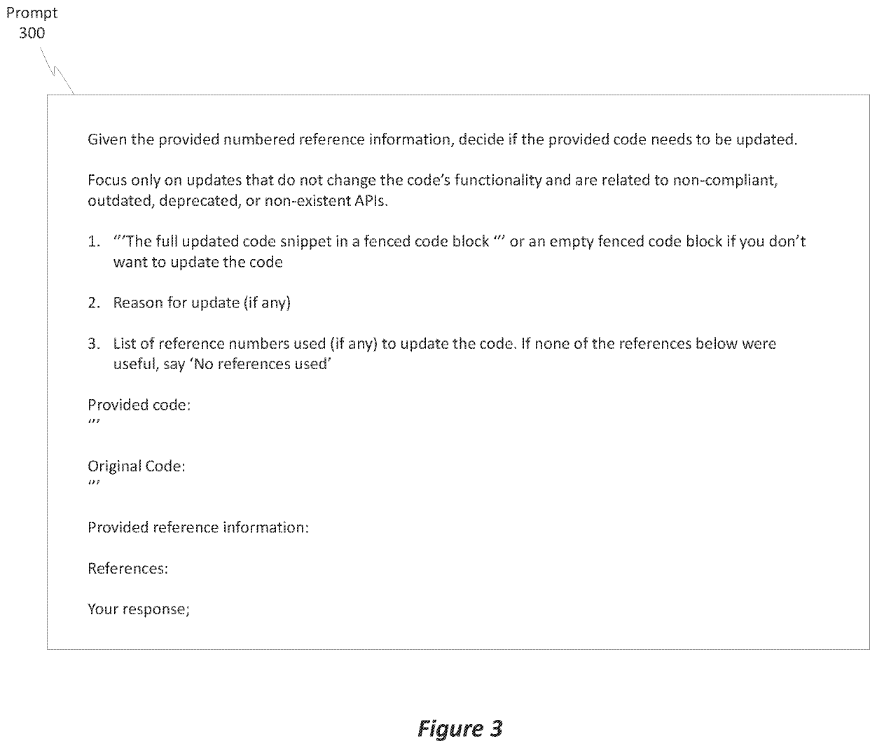

FIG. 3 shows an example of a prompt 300 that is representative of prompt 140. One will appreciate how the text used in this prompt is being provided for illustrative purposes only, and the exact language and examples provided herein should not be viewed as being limiting to the disclosed principles.

Prompt 300 includes various text segments. One segment includes the following language: “Given the provided numbered reference information, decide if the provided code needs to be updated.” This segment instructs the LLM 110 to determine whether the user's code should be updated.

Another segment may optionally include the following language: “Focus only on updates that do not change the code's functionality and are related to non-compliant, outdated, deprecated, or non-existent APIs.” This segment operates to constrain the operations of the LLM 110 to a particular task.

Prompt 300 then includes some additional conditions or constraints. One requirement is the following: “The full updated code snippet in a fenced code block or an empty fenced code block if you don't want to update the code.” Another requirement is the following: “Reason for update (if any).” Another requirement is: “List of reference numbers used (if any) to update the code. If none of the references below were useful, say ‘No references used’.” Many references can be included in the prompt 300. Indeed, it is often the case that many references (e.g., 10, 20, 30, 40, or more than 40) may be included in the prompt 300. Although not shown, the prompt 300 may further include example code mappings that map code from one API or library to another API or library.

Returning to FIG. 1, after building the prompt 140, service 105 then feeds the prompt 140 into the LLM 110. Doing so triggers the LLM 110 to operate based on the information included in the prompt 140.

The output of the LLM 110 includes modified code 145, which includes a proposed rewritten version of the code 120. This rewritten version is intended to cause the user's code to now be compliant with the policy 130, such as by including call statements to libraries that are compliant with the policy 130.

For example, in its initial state, the user's code may be calling a library that is determined to not be compliant with policy. In response, the embodiments are able to identify an equivalent library that includes equivalent functionality but that is compliant with the policy. The embodiments can then facilitate the modification of the user's code so that, instead of calling the non-compliant library, the code is rewritten so it now calls the compliant library. The functionality of the user's code remains the same, but the code is now compliant whereas previously it was not.

In some cases, multiple portions of the user's code may need to be rewritten so that the user's code correctly calls the new library. If that is the case, then the output of the LLM 110 can be structured to include these multiple changes.

In some instances, it may be the case that LLM 110 is not able to generate correct or usable output. In such a scenario, the LLM 110 can provide a notice indicating that the code 120 cannot be rewritten in a manner to bring it into compliance with the policy 130. The LLM 110 may also be triggered to provide a justification for its actions.

By way of further clarification, in some implementations, service 105 may task the LLM 110 to provide a justification as to why LLM 110 updated the code 120 the way it did. This request both improves the performance of the LLM 110 (e.g., in the spirit of chain-of-thought prompting) and provides additional information to a human developer. Based on the prompt 140, LLM 110 then generates the modified code 145, which is a modified version of the user's code 120.

In some implementations, service 105 performs a test using the LLM's output. For instance, service 105 may attempt to determine whether the provided response is actual, executable code. This test can optionally be performed by running the output through a test environment to determine whether the code is executable.

Service 105 then presents the rewritten or modified code 145 to the user, optionally in that user's integrated development environment (IDE). In some scenarios, the modified code 145 is presented as a replacement for the original code 120. In some scenarios, the modified code 145 is presented as a selectable and suggested update to the original code 120. For example, the modified code 120 can be presented in the form of a quick fix.

In some scenarios, the modified code 145 is displayed simultaneously with the code 120 and at a position that is proximate to the code 120. In some cases, the modified code 145 is presented as at least partially overlapping and hiding the code 120.

In some cases, the output of the LLM is displayed while the user's codebase is still under development. For instance, the disclosed operations can occur while the user is developing the code, such that the LLM's output is surfaced to the user in a manner that appears to essentially be contemporaneous with the code drafting being performed by the developer.

Optionally, service 105 can display confidence metrics that the LLM 110 generated. These confidence scores reflect how confident LLM 110 is that the replacement code is suitable for inclusion into the user's code. In some cases, the confidence score can further reflect whether the replacement code has been tested and verified that it will work.

In some embodiments, service 105 may include the initial output of the LLM in a feedback prompt that is subsequently fed back into the LLM. This feedback prompt may be designed to try to improve the results of the LLM. For instance, if the LLM attempted to update code but did so in an incorrect manner, as reviewed by the developer, the embodiments may trigger the generation of the feedback prompt with additional details in that prompt to inform the LLM how its last output was not sufficient. Any number of iterations may be performed in an attempt to correctly update the user's code.

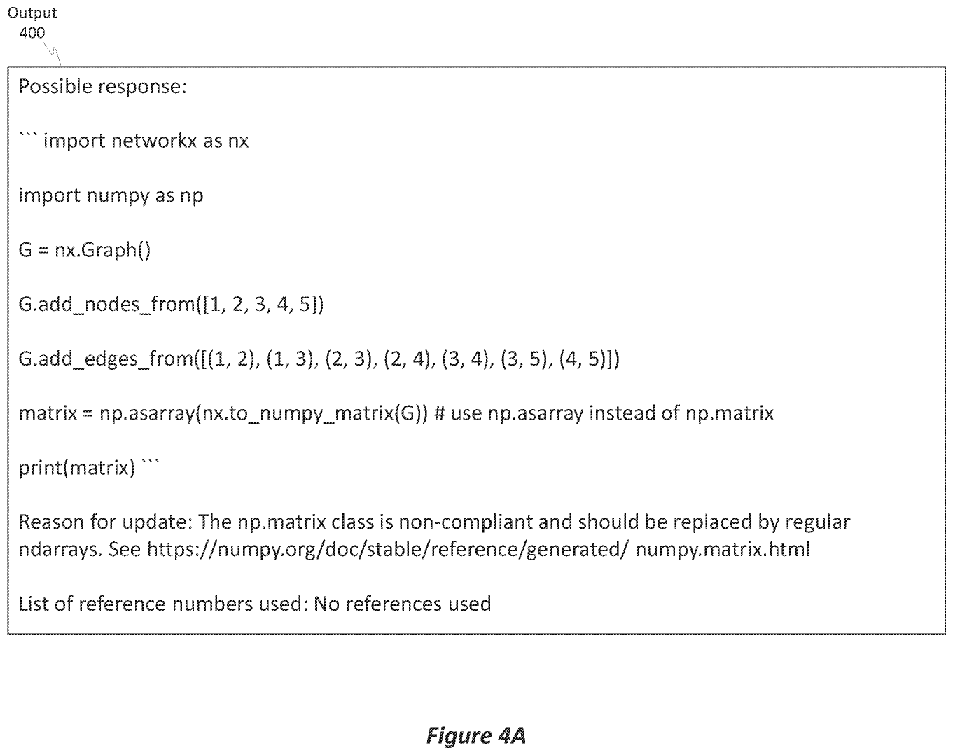

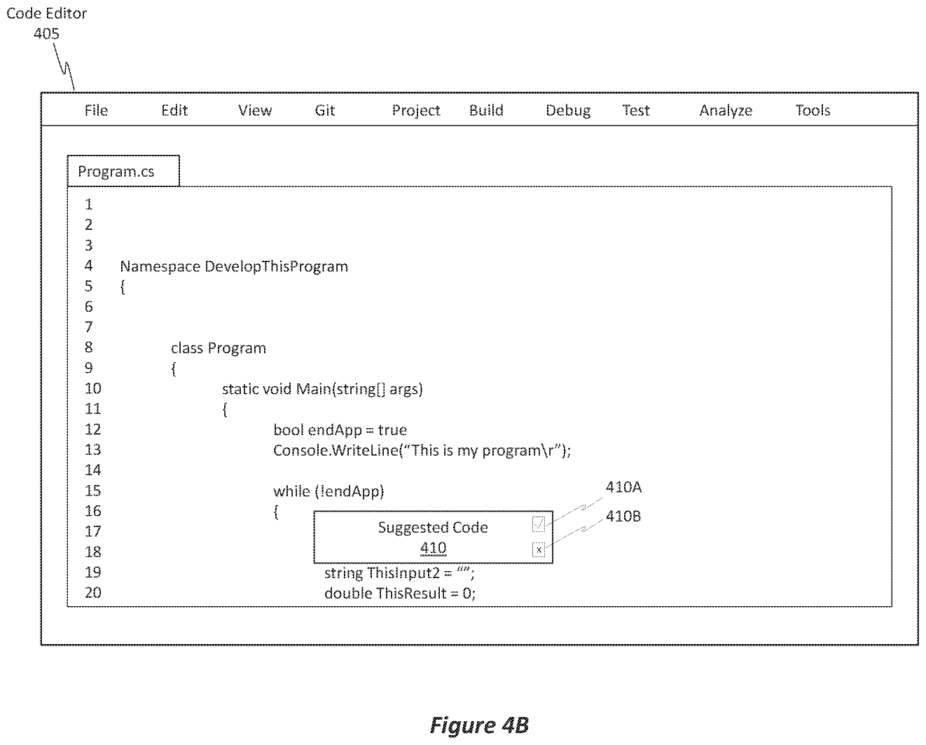

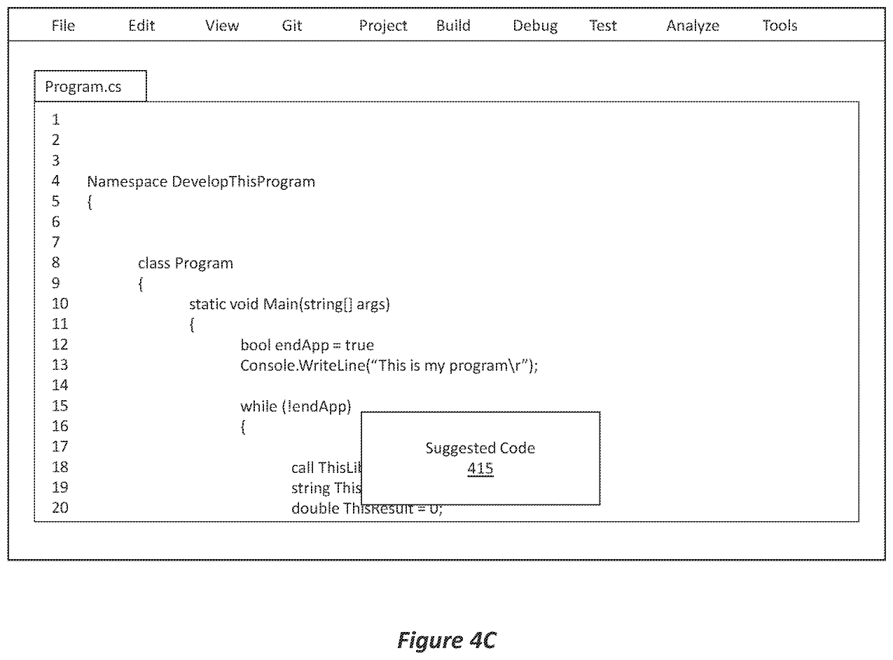

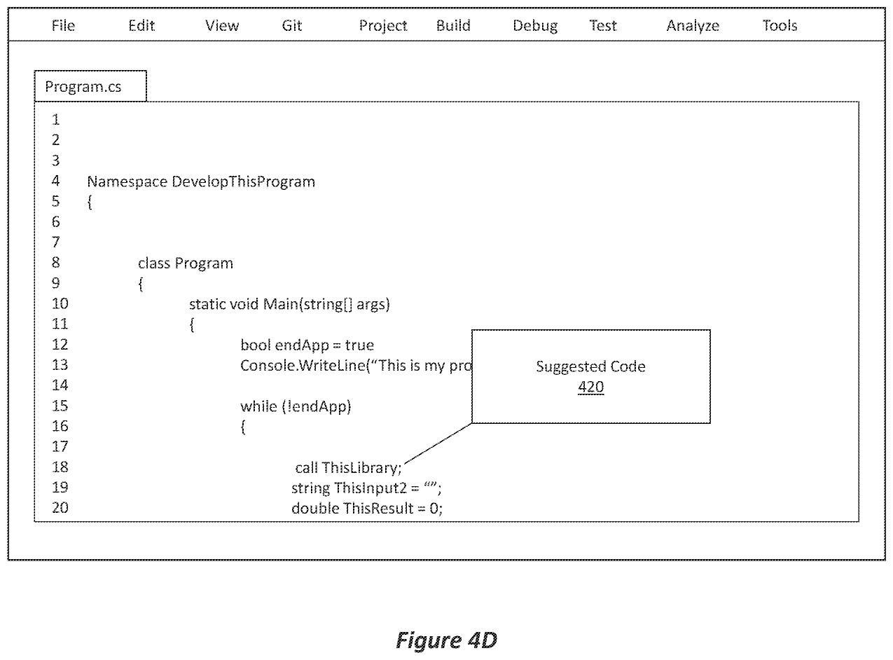

FIG. 4A shows an example of the output 400 that can be generated by the LLM 110 of FIG. 1. Notice, the output 400 includes various changes as well as a reason for why the LLM 110 is recommending these changes. FIG. 4B shows a code editor 405, such as an integrated development environment (IDE). The modified code output generated by the LLM can be displayed within the window of the code editor 405.

For example, FIG. 4B shows a scenario where the LLM's output (i.e. in the form of the suggested code 410) is displayed at a position that entirely overlaps the code that is being operated on by the LLM. Optionally, a selectable option can be displayed to accept the LLM's suggestion. For example, the selectable option 410A is an option to accept the suggested code 410, resulting in that code being automatically incorporated or adopted into the codebase. For instance, if the user accepts the suggestion, the service 105 can automatically incorporate that new code into the codebase, thereby replacing the previous code. Alternatively, selectable option 410B is an option to reject the suggested code 410, resulting in that code not being implemented into the codebase. That is, the code (e.g., proposed rewritten version of the user's code snippet) is prevented from being included in the codebase. In some implementations, the user can provide feedback as to why that suggestion is not being used. This feedback may later be used by the service when building subsequent prompts, and the feedback may improve the operations of the LLM.

FIG. 4C shows an example scenario in which the suggested code 415 is only partially displayed overtop of code that was acted on by the LLM. FIG. 4D shows an example scenario in which the suggested code 420 is displayed proximately to the code that was acted on by the LLM, but the suggested code 420 is not displayed over top of that code. In some cases, a guideline can be used to link or associate the suggested code 420 with the underlying code.

### Example Methods

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

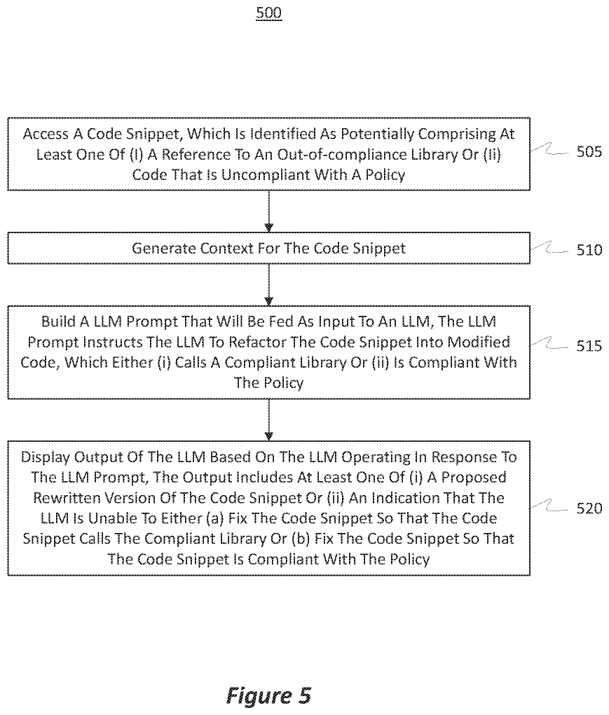

Attention will now be directed to FIG. 5, which illustrates a flowchart of an example method 500 for intelligently prompting a large language model (LLM) to refactor code. Method 500 can be implemented within the architecture 100 of FIG. 1; furthermore, method 500 can be performed by the service 105. Typically, the LLM is a generative pre-trained transformer type of LLM. The LLM can be hosted by a first party or a third party.

Method 500 includes an act (act 505) of accessing a code snippet. This code snippet is identified as potentially comprising at least one of (i) a reference to an out-of-compliance library or (ii) code that is uncompliant with a policy. Code 120 from FIG. 1 is an example of this code snippet. Similarly, one of the libraries 135 may be the one referenced above.

Often, this code snippet is included in a codebase that is being developed by a user or developer. As discussed previously, it is sometimes the case that developers use non-compliant or deprecated code in their codebases. When APIs update or change over time, that code may cause the developer's codebase to break or become non-compliant. As a result, it is desirable to update the code snippet to reflect compliant code, such as code that complies with a specific policy or code that calls an API or library that is compliant with the policy. The embodiments may determine that the code is non-compliant by inserting parsed portions of the code into a dependency graph to determine whether the code is up-to-date and/or compliant.

By way of further detail, in some cases, the process of accessing the code snippet includes parsing a codebase comprising the code snippet, resulting in generation of parsed data. Parsing the codebase may then include parsing a manifest associated with the codebase, parsing a lockfile associated with the codebase, and/or parsing metadata associated with the codebase. The above process may further include inserting the parsed data into a dependency graph, which includes version data, license data, policy data, and vulnerability data for a set of libraries. That is, the dependency graph may also include vulnerability data, lockfile data, and other data about the different dependencies and versions of a set of libraries. The above process may then further include determining, based on the dependency graph, that the code snippet does include the reference to the out-of-compliance library.

Act 510 includes generating context for the code snippet. Optionally, the context may include content obtained from a selected number of lines of code preceding the code snippet. As another option, the context may include content obtained from a selected number of lines of code succeeding the code snippet. For instance, the prior 1, 2, 3, 4, 5, 6, 7, 8, 9, 10, or more than 10 lines of code may be included in the context. Similarly, the subsequent 1, 2, 3, 4, 5, 6, 7, 8, 9, 10, or more than 10 lines of code may be included in the context.

In some implementations, those lines of code may be fed into the LLM, and the LLM may be tasked with generating a summary of how the code snippet is being used within those lines. Then, instead of those actual lines being included in the prompt, the summary of how the code snippet is being used is fed into the prompt.

In some implementations, the context may include function information for a function associated with the code snippet. Optionally, the context may include class information for a class associated with the code snippet. The context may also include file information for a file that includes or is being accessed by the code snippet.

Optionally, there may be an act of generating and/or accessing one or more mappings that map the out-of-compliance library to a library that is determined to be compliant. These mappings can be obtained from any source, including forum data, release note data, the Internet, and so on. In this manner, some embodiments identify which new library is to be used as the replacement for the previous (non-compliant) library. Once this new library is identified, the embodiments can then attempt to determine how to modify the user's code so that it no longer calls the old library, rather, the code now calls the new library.

Act 515 includes building a large language model (LLM) prompt that will be fed as input to an LLM. The LLM prompt instructs the LLM to refactor the code snippet into modified code, which either (i) calls a compliant library or (ii) is compliant with the policy. Optionally, the prompt may be structured to include the mappings mentioned above and may include the specific new library that is to be used. The library that is determined to be compliant may be the same as the “compliant library,” which is called by the modified code. In some cases, the library that is determined to be compliant is different than, though perhaps related to, the compliant library that is called by the modified code. In such a scenario, the LLM may be tasked with attempting to identify a compliant library having the same or sufficiently similar functionality as the old library. Thus, in some scenarios, the library is preselected and presented to the LLM while in other scenarios the library is not preselect (but perhaps other example libraries are made known to the LLM) and the LLM is tasked with attempting to find a suitable replacement library.

Act 520 then includes displaying output of the LLM based on the LLM operating in response to the LLM prompt. The output includes at least one of (i) a proposed rewritten version of the code snippet or (ii) an indication that the LLM is unable to either (a) fix the code snippet so that the code snippet calls the compliant library or (b) fix the code snippet so that the code snippet is compliant with the policy.

The disclosed service is also able to crawl public networks in an attempt to identify conversations, information, or other code that may be relevant to the current task of the LLM. This supplemental information can also be included in the LLM prompt.

In some scenarios, the release notes or the public network data may include a code mapping detailing how to map a non-compliant version of code to a compliant version of code. Optionally, the release notes or public network data may include natural language detailing how the non-compliant version of code is transformable to the compliant version of code. Optionally, the supplemental data may include a combination of natural language and code. As another option, the supplemental data may include other information on how to update one version of code to a different/alternative version of code.

In some scenarios, the supplemental data (e.g., mappings) may operate as examples and may not have a close match to the developer's code or to the compliant code (e.g., these example libraries may not be suitable replacement libraries and thus should operate as examples only and not replacements). The embodiments attempt to identify whatever supplemental data may be best attributed or matched with the developer's code. Even if a complete match is not found, example mappings and supplemental data can be used to help guide the LLM in updating code and possibly in selecting a new library to use. Optionally, the LLM may be tasked with providing a rationale or justification as to why it selected a particular replacement library. In some cases, this justification may include a mapping tree or mapping data to show how closely the two libraries match one another or where they diverge.

The output generated by the LLM can include modified code language that conforms with certain policy. It may be the case that specific statements, such as call statements or other declarations, have changed as the APIs were updated over time, resulting in perhaps those calls statements being non-compliant or perhaps in the API/library itself no longer being compliant with the policy. The embodiments rely on the LLM to learn these changes and to then apply those changes to the developer's own code so that the developer's code can be updated with code that is compliant, such as by calling a library that is compliant with policy. Notably, the functionality of the developer's code is designed to remain consistent (despite a different API or library now potentially being called), but the syntax may change, such as by calling a different library that is compliant with the policy.

The LLM's output may further include one or more selectable options to accept or reject the output. The proposed rewritten version of the code snippet can also be automatically incorporated into a codebase such that the proposed rewritten version of the code snippet replaces the code snippet in the codebase. In some implementations, the output is displayed proximately to the code snippet. In some cases, the output further includes a rationale associated with the proposed rewritten version of the code snippet. The output can also identify the replacement library/API and can include details on how close this new library is with respect to the previous library.

In some cases, the output generated by the LLM is provided in a feedback prompt, which is subsequently fed back into the LLM in an attempt to improve the LLM's output through multiple iterations of execution. In some implementations, the LLM can also be tasked with providing a confidence metric to inform the user how confident the LLM is with regard to its output, including the code modification as well as the selection of the replacement library.

Accordingly, the disclosed embodiments are able to intelligently and automatically update a user's codebase in response to a determination that the user's codebase may potentially include code that is not currently in compliance with policy. In performing these operations, the embodiments improve a computer system's functionality and help improve code.

### Example Computer/Computer Systems

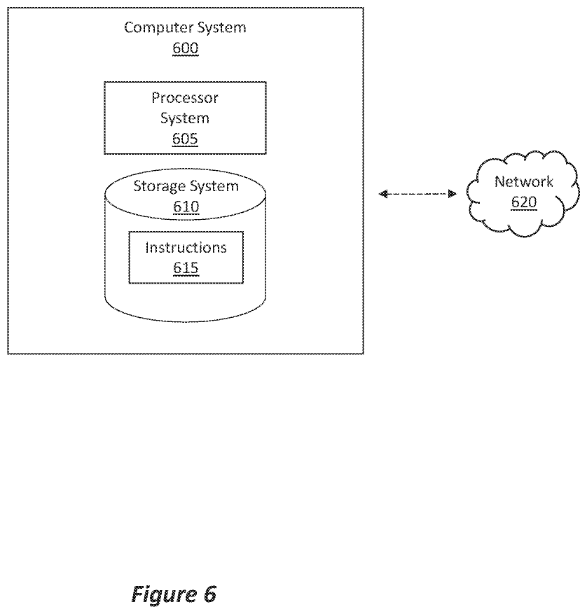

Attention will now be directed to FIG. 6 which illustrates an example computer system 600 that may include and/or be used to perform any of the operations described herein. Computer system 600 may take various different forms. For example, computer system 600 may be embodied as a tablet, a desktop, a laptop, a mobile device, or a standalone device, such as those described throughout this disclosure. Computer system 600 may also be a distributed system that includes one or more connected computing components/devices that are in communication with computer system 600. Computer system 600 can implement the service 105 of FIG. 1.

In its most basic configuration, computer system 600 includes various different components. FIG. 6 shows that computer system 600 includes a processor system 605 that includes one or more processor(s) (aka a “hardware processing unit”) and a storage system 610.

Regarding the processor(s) of the processor system 605, it will be appreciated that the functionality described herein can be performed, at least in part, by one or more hardware logic components. For example, and without limitation, illustrative types of hardware logic components/processors that can be used include Field-Programmable Gate Arrays (“FPGA”), Program-Specific or Application-Specific Integrated Circuits (“ASIC”), Program-Specific Standard Products (“ASSP”), System-On-A-Chip Systems (“SOC”), Complex Programmable Logic Devices (“CPLD”), Central Processing Units (“CPU”), Graphical Processing Units (“GPU”), or any other type of programmable hardware.

As used herein, the terms “executable module,” “executable component,” “component,” “module,” “service,” or “engine” can refer to hardware processing units or to software objects, routines, or methods that may be executed on computer system 600. The different components, modules, engines, and services described herein may be implemented as objects or processors that execute on computer system 600 (e.g. as separate threads).

Storage system 610 may include physical system memory, which may be volatile, non-volatile, or some combination of the two. The term “memory” may also be used herein to refer to non-volatile mass storage such as physical storage media. If computer system 600 is distributed, the processing, memory, and/or storage capability may be distributed as well.

Storage system 610 is shown as including executable instructions 615. The executable instructions 615 represent instructions that are executable by the processor(s) of processor system 605 to perform the disclosed operations, such as those described in the various methods.

The disclosed embodiments may comprise or utilize a special-purpose or general-purpose computer including computer hardware, such as, for example, one or more processors and system memory, as discussed in greater detail below. Embodiments also include physical and other computer-readable media for carrying or storing computer-executable instructions and/or data structures. Such computer-readable media can be any available media that can be accessed by a general-purpose or special-purpose computer system. Computer-readable media that store computer-executable instructions in the form of data are “physical computer storage media” or a “hardware storage device.” Furthermore, computer-readable storage media, which includes physical computer storage media and hardware storage devices, exclude signals, carrier waves, and propagating signals. On the other hand, computer-readable media that carry computer-executable instructions are “transmission media” and include signals, carrier waves, and propagating signals. Thus, by way of example and not limitation, the current embodiments can comprise at least two distinctly different kinds of computer-readable media: computer storage media and transmission media.

Computer storage media (aka “hardware storage device”) are computer-readable hardware storage devices, such as RAM, ROM, EEPROM, CD-ROM, solid state drives (“SSD”) that are based on RAM, Flash memory, phase-change memory (“PCM”), or other types of memory, or other optical disk storage, magnetic disk storage or other magnetic storage devices, or any other medium that can be used to store desired program code means in the form of computer-executable instructions, data, or data structures and that can be accessed by a general-purpose or special-purpose computer.

Computer system 600 may also be connected (via a wired or wireless connection) to external sensors (e.g., one or more remote cameras) or devices via a network 620. For example, computer system 600 can communicate with any number devices or cloud services to obtain or process data. In some cases, network 620 may itself be a cloud network. Furthermore, computer system 600 may also be connected through one or more wired or wireless networks to remote/separate computer systems(s) that are configured to perform any of the processing described with regard to computer system 600.

A “network,” like network 620, is defined as one or more data links and/or data switches that enable the transport of electronic data between computer systems, modules, and/or other electronic devices. When information is transferred, or provided, over a network (either hardwired, wireless, or a combination of hardwired and wireless) to a computer, the computer properly views the connection as a transmission medium. Computer system 600 will include one or more communication channels that are used to communicate with the network 620. Transmissions media include a network that can be used to carry data or desired program code means in the form of computer-executable instructions or in the form of data structures. Further, these computer-executable instructions can be accessed by a general-purpose or special-purpose computer. Combinations of the above should also be included within the scope of computer-readable media.

Upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”) and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions comprise, for example, instructions that cause a general-purpose computer, special-purpose computer, or special-purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the embodiments may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The embodiments may also be practiced in distributed system environments where local and remote computer systems that are linked (either by hardwired data links, wireless data links, or by a combination of hardwired and wireless data links) through a network each perform tasks (e.g. cloud computing, cloud services and the like). In a distributed system environment, program modules may be located in both local and remote memory storage devices.

The present invention may be embodied in other specific forms without departing from its characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for intelligently prompting a large language model (LLM) to refactor code, said method comprising:
accessing a code snippet, which is identified as potentially comprising a reference to an out-of-compliance library;
generating context for the code snippet;
building an LLM prompt that will be fed to the LLM, wherein the LLM prompt instructs the LLM to refactor the code snippet into modified code, which calls a compliant library; and
displaying output of the LLM based on the LLM operating in response to the LLM prompt, wherein the output includes a proposed rewritten version of the code snippet.

2. The method of claim 1, wherein the method further includes generating one or more mappings that map the out-of-compliance library to a library that is determined to be compliant, and wherein the prompt is structured to include the one or more mappings.

3. The method of claim 2, wherein the library that is determined to be compliant is the same as the compliant library that is called by the modified code.

4. The method of claim 2, wherein the library that is determined to be compliant is different than the compliant library that is called by the modified code.

5. The method of claim 1, wherein the context includes content obtained from a selected number of lines of code preceding the code snippet.

6. The method of claim 1, wherein the context includes content obtained from a selected number of lines of code succeeding the code snippet.

7. The method of claim 1, wherein the context includes function information for a function associated with the code snippet or class information for a class associated with the code snippet or file information for a file that is called by the code snippet.

8. The method of claim 1, wherein the LLM is a generative pre-trained transformer type of LLM.

9. The method of claim 1, wherein accessing the code snippet, which is identified as potentially comprising the reference to the out-of-compliance library, includes:
parsing a codebase comprising the code snippet, resulting in generation of parsed data;
inserting the parsed data into a dependency graph, which includes version data for a set of libraries; and
determining, based on the dependency graph, that the code snippet does include the reference to the out-of-compliance library.

10. The method of claim 9, wherein parsing the codebase includes parsing a manifest associated with the codebase, parsing a lockfile associated with the codebase, or parsing metadata associated with the codebase.

11. A computer system comprising:
a processor system; and
a storage system that includes instructions that are executable by the processor system to cause the computer system to:
access a code snippet, which is identified as potentially comprising code that is uncompliant with a policy;
generate context for the code snippet;
build a large language model (LLM) prompt that will be fed as input to an LLM, wherein the LLM prompt instructs the LLM to refactor the code snippet into modified code, which is designed to be compliant with the policy; and
display output of the LLM based on the LLM operating in response to the LLM prompt, wherein the output includes a proposed rewritten version of the code snippet.

12. The computer system of claim 11, wherein the output further includes a selectable option to accept the output into a codebase comprising the code snippet or, alternatively, to reject the output such that the proposed rewritten version of the code snippet is prevented from being included in the codebase.

13. The computer system of claim 11, wherein the proposed rewritten version of the code snippet is automatically incorporated into a codebase such that the proposed rewritten version of the code snippet replaces the code snippet in the codebase.

14. The computer system of claim 11, wherein the output is displayed proximately to the code snippet.

15. The computer system of claim 11, wherein the proposed rewritten version of the code snippet is refactored code, which functions the same as the code snippet despite having different syntax and which is now compliant with the policy.

16. The computer system of claim 11, wherein the prompt further includes example code mappings showing how a previous version of code, which is uncompliant with certain policy, is refactored into a new version of code, which is compliant with the certain policy.

17. The computer system of claim 11, wherein the output further includes a rationale associated with the proposed rewritten version of the code snippet, the rationale including a reason as to why the LLM generated the output.

18. A method comprising:
accessing a code snippet, which is identified as potentially comprising at least one of (i) a reference to an out-of-compliance library or (ii) code that is uncompliant with a policy;
generating context for the code snippet;
building a large language model (LLM) prompt that will be fed as input to an LLM, wherein the LLM prompt instructs the LLM to refactor the code snippet into modified code, which either (i) calls a compliant library or (ii) is compliant with the policy; and
displaying output of the LLM based on the LLM operating in response to the LLM prompt, wherein the output includes at least one of (i) a proposed rewritten version of the code snippet or (ii) an indication that the LLM is unable to either (a) fix the code snippet so that the code snippet calls the compliant library or (b) fix the code snippet so that the code snippet is compliant with the policy.

19. The method of claim 18, wherein the LLM prompt operates to constrain the LLM to design the proposed rewritten version of the code snippet based on the compliant library.

20. The method of claim 18, wherein the code snippet is included in a codebase, and wherein the output of the LLM is displayed while the codebase is still under development.
